(19) United States
(12) Patent Application Publication
(10) Pub. No.: US 2011/0076859 A1
(43) Pub. Date: Mar. 31, 2011

(54) MOTHERBOARD, PORT AND CONDUCTIVE TERMINAL STRUCTURE OF CONNECTORS USED THEREIN

(75) Inventor: CHI-CHANG TSAI, YUNLIN COUNTY (TW)

(73) Assignee: ELITEGROUP COMPUTER SYSTEMS CO., LTD., TAIPEI CITY (TW)

(21) Appl. No.: 12/702,388

(22) Filed: Feb. 9, 2010

(30) Foreign Application Priority Data
Sep. 30, 2009 (TW) 98218073

(51) Int. Cl. H01R 13/03; H01R 12/00; H01R 13/02

(52) U.S. Cl. 439/55; 439/884; 439/887

(57) ABSTRACT

A motherboard includes a printed circuit board and plural connectors. The connectors, which include sockets and ports, are mounted on the printed circuit board. Each of the connectors has plural conductive terminals. Each conductive terminal has a substrate layer and an electroplating layer formed on surfaces of the substrate layer. The electroplating layer has a thickness between 0.000128 mm. and 0.00128 mm. The electroplating layer can use the material of Au, Ag, Pt or Pd.

### BACKGROUND OF THE INVENTION

1. Field of the Invention

The present invention relates to a motherboard, a port and a conductive terminal structure of connectors used therein, and more particularly to a terminal structure of connectors, a port and a motherboard having the terminal structure, which are installed in a computer.

2. Description of Related Art

As shown in FIG. 1 which is a perspective view of a conventional motherboard. A conventional motherboard 3 in the computer commonly includes plural types of sockets 30 and ports 32. Furthermore, each socket 30 on the motherboard 3 has plural conductive terminals (not labeled), for receiving a matching component (not labeled) plugged therein. For example, a memory socket 30a is provided for a memory 4 plugged therein. When the memory 4 is plugged in the memory socket 30a, the memory 4 can be electrically connected with the components on the motherboard 3. In addition, the port 32 on the motherboard 3 also has plural conductive terminals (not labeled) which are used to receive a matching plug (not labeled) plugged therein. For example, an USB port 32a is provided for receiving an USB plug 5 plugged therein. When the USB plug 5 is plugged in the USB port 32a, the USB plug 5 can be electrically connected with components on the motherboard 3.

If computer players repeatedly exchange the components on the motherboard, such frequent plug-plug actions will wear down the conductive terminals in the sockets or ports on the motherboard. An electroplating layer on the conductive terminals will disappear, and a copper substrate under the electroplating layer will be exposed in the air. The copper substrate exposed in air for a long time will result in oxidization, and the function of the conductive terminal will be affected.

Furthermore, even the components on the motherboard are not repeatedly exchanged by computer players, the moisture in the air or the sulfuric molecules in special environment (such as, hot spring area) also will speed the electroplating layer of the conductive terminals of the sockets or ports be consumed. The life time of the sockets or ports can be shortened. In additional, the high temperature environment also will cause the electroplating layer of the sockets or ports to cause an unstable condition, such unstable condition will affect the function of the conductive terminals.

### SUMMARY OF THE INVENTION

According to the present invention, a motherboard has connectors which have conductive terminals formed with an electroplating layer on surfaces thereof. Furthermore, the electroplating layer has a thickness between 0.000128 mm. and 0.00128 mm. Moreover, the electroplating layer can use the material of Au (aurum), Ag (silver), Pt (platinum) or Pd (palladium).

One embodiment of the present invention provides a motherboard which includes a printed circuit board and a plurality of connectors. The plural connectors are mounted on the printed circuit board. Each connector has a plurality of conductive terminals, and each of the conductive terminals has a substrate layer and an electroplating layer formed on surfaces of the substrate layer. The electroplating layer has a thickness between 0.000128 mm. and 0.00128 mm. The electroplating layer can use the material of Au, Ag, Pt or Pd. The connectors could be sockets or ports.

Another embodiment of the present invention provides a connector having conductive terminals, which includes a substrate layer and an electroplating layer formed on surfaces of the substrate layer. The thickness of the electroplating layer between 0.000128 mm. and 0.00128 mm. The electroplating layer can use the material of Au, Ag, Pt or Pd.

In conclusion, the present invention motherboard provides the conductive terminals of the connectors coated with the electroplating layer, which has a thickness between 0.000128 mm. and 0.00128 mm. and the material used thereon could be Au, Ag, Pt or Pd. Therefore, the motherboard of the present invention provides the conductive terminals of the sockets and the ports for effectively avoiding the problem of been worn down because of frequent exchanging accessories. Moreover, in special conditions of environments, the present invention provides the connectors on the motherboard for being able to have a longer life time and higher reliability than conventional ones.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

FIG. 1 is a perspective view of a conventional motherboard;

FIG. 2 is a top view of a motherboard according to the present invention;

FIG. 2A is a bottom view of a memory socket according to the present invention;

FIG. 2B to FIG. 2D are bottom views of each kinds of CPU socket according to the present invention;

FIG. 2E is a front view of a conductive terminal according to the present invention;

FIG. 3 is a side view of the motherboard according to the present invention;

FIG. 4 is a cross-sectional view of a conductive terminal of the socket according to the present invention; and

FIG. 5 is a cross-sectional view of a conductive terminal of the port according to the present invention.

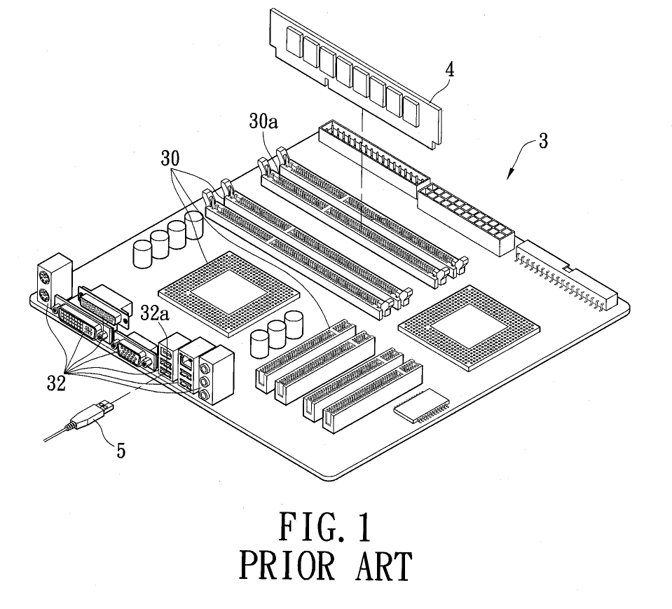

### DETAILED DESCRIPTION OF THE PREFERRED EMBODIMENTS

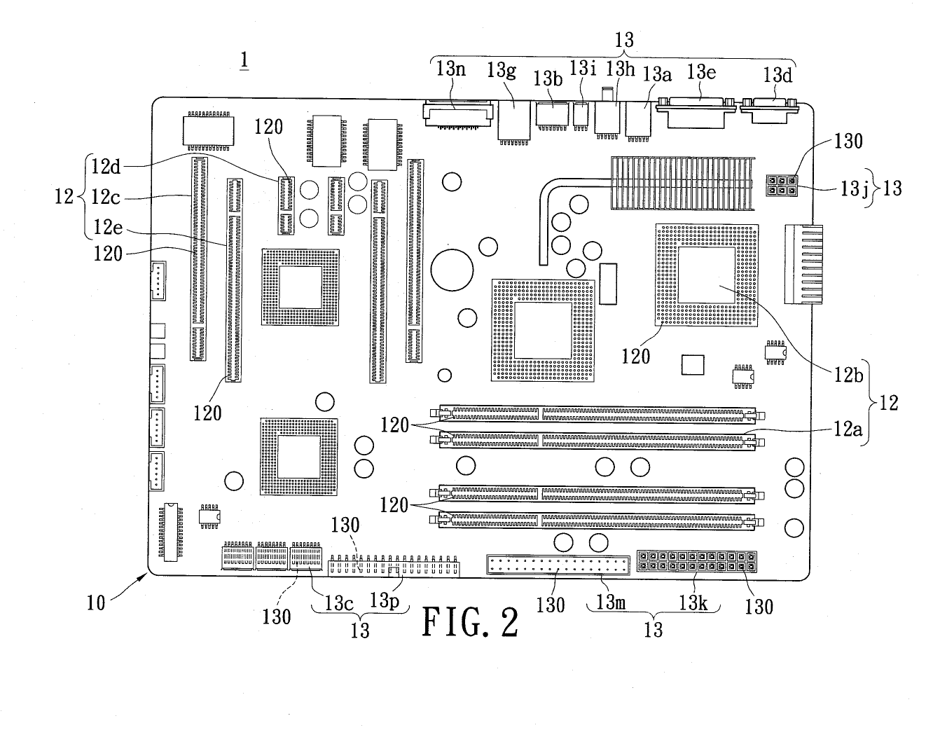

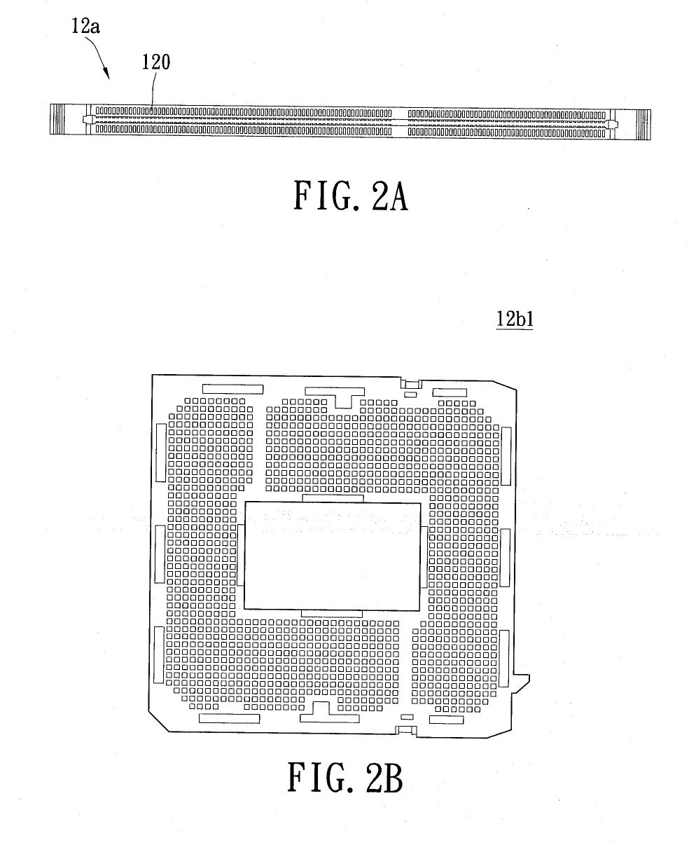

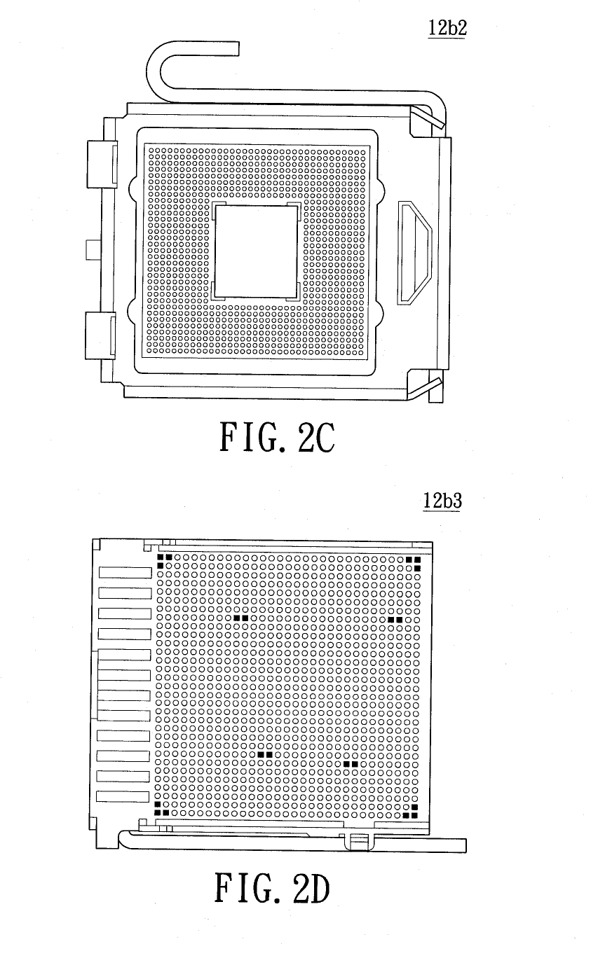

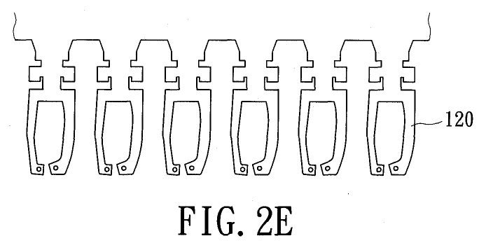

Reference is made to FIG. 2. FIG. 2 is a top view of a motherboard according to the present invention. This embodiment provides a motherboard 1 including a printed circuit board 10 and a plurality of connectors (including plural sockets 12 and ports 13). In this embodiment, the motherboard 1 could be an ATX (Advanced Technology Extended) motherboard, a micro ATX (micro Advanced Technology Extended) motherboard, a flex ATX (flex Advanced Technology Extended) motherboard, a WTX motherboard, a BTX (Balanced Technology eXtended) motherboard or other type of motherboard having sockets.

Reference is also made to FIG. 2. A printed circuit board 10 mounted with a plurality of connectors, such as sockets 12. Each socket 12 has a plurality of conductive terminal 120. The conductive terminal 120 are electrically connected with the printed circuit board 10. The sockets 12 of the printed circuit board 10 includes a memory socket 12a, a CPU socket 12b, a PCI socket 12c, a PCI-E x1 socket 12d and a PCI-E x16 socket 12e, or one of them or their combination. A number of pins of the CPU socket 12b would be fitted for an AMD CPU or an Intel CPU.

Reference is made to FIG. 2 and FIG. 2A. FIG. 2A is a top view of a memory socket according to the present invention. The memory socket 12a of the present invention has 240 conductive terminals 120, which is fitted for a DDR (Double Data Rate) memory with 240 pins. Reference is made to FIG. 2, FIG. 2B to FIG. 2D. FIG. 2B to FIG. 2D are top views of each kinds of CPU socket according to the present invention. As shown in FIG. 2B, an embodiment illustrated by the present invention has a CPU socket 12b1 which is applied to LGA 1156 processor manufactured by Intel Corporation. As shown in FIG. 2C, an embodiment illustrated by the present invention has a CPU socket 12b2 which is applied to a LGA 775 processor manufactured by Intel Corporation. As shown in FIG. 2D, an embodiment illustrated by the present invention has a CPU socket 12b3 which is applied to a SMT AM3 processor manufactured by Advanced Micro Devices, Inc.

Reference is made to FIG. 2 and FIG. 2E. FIG. 2E is a front view of a conductive terminal 120 according to the present invention. The conductive terminal 120 is assembled in the sockets 12.

Reference is made to FIG. 4. FIG. 4 is a cross-sectional view of a conductive terminal of the socket according to the present invention. In the socket 12 of this embodiment, each conductive terminal 120 has a substrate layer 1202, and two surfaces of the substrate layer 1202 are formed with an electroplating layer 1204 respectively. The substrate layer 1202 would use the material of copper or copper alloy. In this embodiment, the electroplating layer 1204 has a thickness between 0.000128 mm. to 0.00128 mm. Furthermore, the electroplating layer 1204 can use the material of Au, Ag, Pt or Pd.

This embodiment in the present invention provides the electroplating layer 1204 used the above-mentioned material and increased the thickness, so that the conductive terminal 120 of the socket 12 can effectively avoid the problem of been worn down because of frequent exchanging accessories. Furthermore, in special conditions of environments, the socket 12 in this embodiment could have a longer life time and higher reliability than conventional socket.

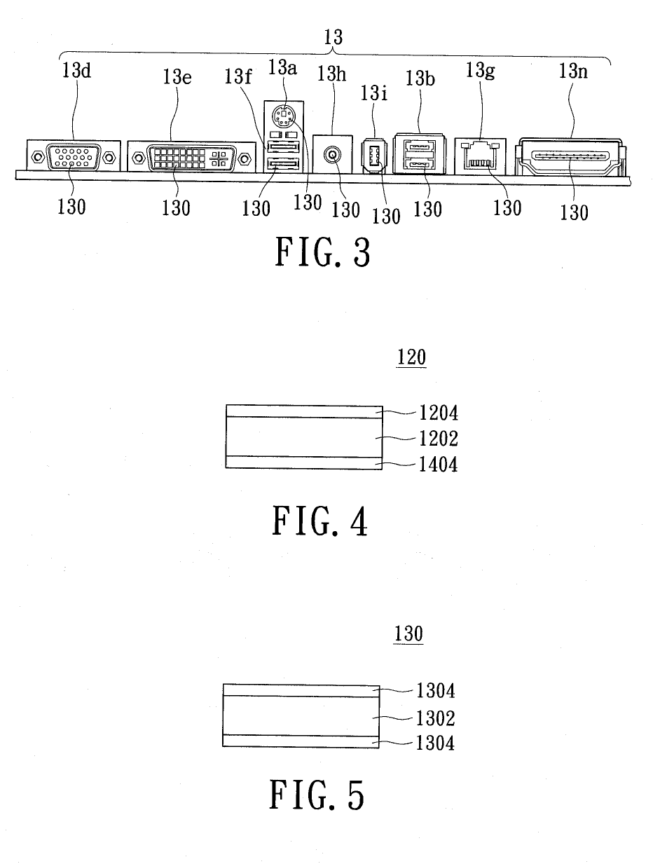

Reference is made to FIG. 2 and FIG. 3. FIG. 3 is a side view of the motherboard according to the present invention. The plural connectors, which are mounted on the printed circuit board 10 of this embodiment, further have a plurality of ports 13 (13a, 13b, 13c, 13d, 13e, 13f, 13g, 13h, 13i, 13j, 13k, 13m, 13n, 13p). Each of the ports 13 has a plurality of conductive terminals 130. The conductive terminal 130 are electrically connected with the printed circuit board 10. The ports 13 on the printed circuit board 10 includes a PS/2 port 13a, an E-SATA port 13b, a SATA port 13c, a VGA port 13d, a DVI port 13e, an USB port 13f, an internet port 13g, an Audio/Video port 13h, an IEEE1394 port 13i, a CPU power port 13j, a motherboard power port 13k, a FDD port 13m, a HDMI port 13n and an ATA port 13p, which would be one of them or an assembly among them. These ports 13 are the best mode used the terminals of the present invention.

Reference is made to FIG. 5. FIG. 5 is a cross-sectional view of a conductive terminal of ports according to the present invention. In the port 13 of this embodiment, each conductive terminal 130 includes a substrate layer 1302, and two surfaces of the substrate layer 1302 are formed with an electroplating layer 1304, respectively. The material of the substrate layer 1302 could be Cu (Copper) and Ni (Nickel) or an alloy of Cu and Ni. The alloy of Cu could be CuSn. In this embodiment, the electroplating layer 1304 has a thickness between 0.000128 mm. and 0.00128 mm. The electroplating layer 1304 can use the material of Au, Ag, Pt or Pd.

An testing experiment data for thickness of standard electroplating layer according the present invention is as follows:

| | | |
|---|---|---|
| Material | Au | Ni |

| Average | 0.00043 | mm. | 0.00191 | mm. |
|---|---|---|---|---|
| Testing Time | 5 | sec. | 5 | sec. |
| Standard Deviation | 0.0000102 | mm. | 0.0000653 | mm. |
| Rate Of Change | 2.37% | | 3.43% | |
| Data Number | 5 | | 5 | |
| Range | 0.000027 | mm. | 0.000172 | mm. |
| Minimum | 0.00042 | mm. | 0.00183 | mm. |
| Maxmum | 0.000443 | mm. | 0.002 | mm. |

Therefore, because of the material used in the electroplating layer 1304 and increase of thickness, the conductive terminal 130 of the port 13 in this embodiment can effectively avoid the problem of been worn down because of frequent exchanging accessories. Furthermore, in special conditions of environments, the port 13 in this embodiment could have a longer life time and higher reliability than conventional port.

In conclusion, the present invention provides the motherboard 1, wherein the conductive terminal 120, 130 in the sockets 12 and the ports 13 have the electroplating layer 1204, 1304 coated on its surface. Furthermore, the electroplating layer 1204, 1304 has a thickness between 0.000128 mm. and 0.00128 mm. Moreover, the electroplating layer 1204, 1304 can use the material of Au, Ag, Pt or Pd.

Therefore, the present invention provides the conductive terminals 120, 130 of the sockets 12 and the ports 13 on the motherboard 1, which can effectively avoid the problem of been worn down because of frequent exchanging accessories. Moreover, the present invention provides the sockets 12 and the ports 13 on the motherboard 1 have a longer life time and higher reliability than conventional ones.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. A motherboard comprising:
a printed circuit board;
a plurality of connectors mounted on the printed circuit board, each of the connectors having a plurality of conductive terminals, wherein each of conductive terminals includes a substrate layer and an electroplating layer formed on a surface of the substrate layer, wherein a thickness of the electroplating layer is between 0.000128 mm. and 0.00128 mm.

2. The motherboard as claimed in claim 1, wherein a material of the electroplating layer is Au, Ag, Pt or Pd.

3. The motherboard as claimed in claim 1, wherein a material of the substrate layer is Cu and Ni, or an alloy of Cu and Ni.

4. The motherboard as claimed in claim 1, wherein the connector is a socket.

5. The motherboard as claimed in claim 4, wherein the socket is a memory socket, a CPU socket, a PCI socket, a PCI-E x1 socket, or a PCI-E x16 socket.

6. The motherboard as claimed in claim 5, wherein a number of pins of the CPU socket are fitted for that of an AMD processor or an Intel processor.

7. The motherboard as claimed in claim 1, wherein the connector is a port.

8. The motherboard as claimed in claim 7, wherein the port is a PS/2 port, a E-SATA port, an ATA port, a VGA port, a DVI port, an USB port, an internet port, an audio port, an IEEE1394 port, a CPU power port, a motherboard power port a FDD port, a HDMI port, or a SATA port.

9. A conductive terminal structure of connectors, comprising:
a substrate layer; and
an electroplating layer formed on a surface of the substrate layer, the electroplating layer having a thickness between 0.000128 mm. and 0.00128 mm.

10. The conductive terminal structure as claimed in claim 9, wherein a material of the electroplating layer is Au, Ag, Pt or Pd.

11. The conductive terminal structure as claimed in claim 9, wherein a material of the substrate layer is Cu and Ni, or an alloy of Cu and Ni.

12. A port, which is mounted on a motherboard, comprising:
a plurality of conductive terminals, wherein each of conductive terminals includes a substrate layer and an electroplating layer formed on a surface of the substrate layer, wherein a thickness of the electroplating layer is between 0.000128 mm. and 0.00128 mm.

13. The port as claimed in claim 12, wherein a material of the electroplating layer is Au, Ag, Pt or Pd.

14. The port as claimed in claim 12, wherein a material of the substrate layer is Cu and Ni, or an alloy of Cu and Ni.

15. The port as claimed in claim 12, wherein the port is a PS/2 port, a E-SATA port, an ATA port, a VGA port, a DVI port, an USB port, an internet port, an audio port, an IEEE1394 port, a CPU power port, a motherboard power port a FDD port, a HDMI port, or a SATA port.
